(19) United States
(12) Patent Application Publication
(10) Pub. No.: US 2012/0190518 A1
(43) Pub. Date: Jul. 26, 2012

(54) INJECTION MOLD APPARATUS AND METHOD UTILIZING SHAFT ROTATION FOR THE MANUFACTURE OF ROLL DEVICES

(76) Inventors: James Joseph Semler, Versailles, KY (US); David Allen Tinsley, Versailles, KY (US)

(21) Appl. No.: 13/013,808

(22) Filed: Jan. 25, 2011

(51) Int. Cl. G03G 15/06; B29C 45/14

(52) U.S. Cl. 492/28; 264/279

(57) ABSTRACT

A method for manufacturing a roll. The method includes positioning a shaft for the roll within a mold, introducing flowable material into the mold from a first end thereof, rotating the shaft at least about 20 revolutions, and following introducing the flowable material into the mold and rotating the shaft, curing the material at an elevated temperature. The method substantially reduces or otherwise eliminates weld lines and flow lines in the manufactured roll.

### BACKGROUND

1. Technical Field

The present application relates generally to injection molding techniques for the manufacture of rolls, and particularly to injection molding techniques for the manufacture of developer rolls for electrophotographic imaging devices.

2. Description of the Related Art

Monochrome laser printers often utilize a polyurethane developer roll. The developer roll is typically created using a reactive injection molding process that uses a roll mold having a substantially cylindrical shape. Examples of prior developer roll and mold injection techniques may be found in U.S. Pat. Nos. 5,874,172 and 6,767,489, the content of which are hereby incorporated by reference herein in their entirety.

FIGS. 1-3 illustrate the known processing steps for and injection molding process for creating a developer roll. Flowable material enters the mold 1 through a side injection port 3 and flows into the main cavity 5 (FIG. 2) where the flow front is split evenly by the developer roll shaft 7 into two separate, substantially parabolic-shaped flow fronts, as shown in FIG. 3. The parabolic flow fronts continue their path around shaft 7 and meet directly opposite the side injection port 3, creating what is referred to as a “weld line” or “knit line.” Once these flow fronts have contacted each other, the flowable material continues to move upwardly within main cavity 5 so as to fill the cavity. In the process of filling cavity 5, the weld line is seen to continue along the direction of the longitudinal axis of shaft 7 until the weld line is stretched along the entire length of the created developer roll.

Because the viscosity of the base materials of the developer roll is relatively high and the fact that mold systems have been seen to only withstand about 40 psi of pressure before their mix head seals leak, there is relatively little chance to create turbulent mixing to eliminate the weld line. In fact, the Reynolds number, which is a dimensionless number generally used to define laminar and turbulent flow regimes, for a typical cylindrical mold system is approximately 3, whereas a minimum Reynolds number of 2100 defines the onset of turbulent mixing. In order to reach the turbulent mixing regime, one would need to reduce the base materials viscosities by a factor of about 700, which is near physically impossible, or increase the flow rate of the system by the same factor, which would result in pressures well above the mix head pressure rating.

From a mechanical standpoint, a developer roll having a weld line has not been seen to pose a serious problem. However, from an electrical uniformity perspective, a weld line of a developer roll is seen to result in electrical property variation around the circumference of the developer roll during use in an electrophotographic imaging device, which in turn produces print defects. The defect is replicated a number of times on a sheet of media corresponding to the number of revolutions of the developer roll per sheet.

Besides weld lines, injecting material directly at shaft 7 may also produce flow line patterns in a common formation at the gate location. Although these lines are very subtle when looking at the roll, they are very distinct when considering a voltage map of the surface of the developer roller and in some cases printed sheets.

The weld line and flow line patterns are believed to be the result of shear induced phase separation since the formulation components of the developer roller are not completely miscible. If the developer roll formulation materials separate such that a thin layer of one component is at the air interface of the flow front within the mold 1, material property differences are believed likely to exist, such as material density, electrical resistivity, microhardness, etc.

Based upon the foregoing, there is a need for an improved process for manufacturing rolls, and particularly developer rolls, which is relatively simple and inexpensive to implement.

### SUMMARY

Example embodiments overcome shortcomings experienced in prior roll processing techniques and thereby satisfy a need for a process for manufacturing rolls and rolls resulting therefrom.

In accordance with an example embodiment, there is disclosed a process by which flow lines and weld lines are substantially reduced. The example process includes injecting flowable material into a mold; following the flowable material being injected into the mold, rotating one of the shaft and the mold relative to the other; and following the rotating, curing the flowable material. During the rotating, weld lines and flow lines are stretched, thereby reducing their width to the point that the width of any remaining electrical non-uniformities are much less than a single pel dot. In a first embodiment, the shaft is rotated relative to the mold.

### BRIEF DESCRIPTION OF THE DRAWINGS

The above-mentioned and other features and advantages of the various embodiments, and the manner of attaining them, will become more apparent and will be better understood by reference to the accompanying drawings, wherein:

FIG. 1 is a side cross sectional view of an existing mold apparatus illustrating the flow of material therein;

FIGS. 2 and 3 are top cross sectional views of the mold apparatus of FIG. 1;

FIG. 4 is a side, cross sectional view of a mold apparatus in accordance with an example embodiment of the present disclosure;

FIGS. 5, 6 and 7 are top cross sectional views of the mold apparatus of FIG. 4 at various stages during the injection of flowable material therein; and

FIGS. 8A-8C are images of cross sectional views of roll portions created according to an example embodiment of the present disclosure.

### DETAILED DESCRIPTION

The following description and drawings illustrate embodiments sufficiently to enable those skilled in the art to practice it. It is to be understood that the subject matter of this application is not limited to the details of construction and the arrangement of components set forth in the following description or illustrated in the drawings. The subject matter is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present application as defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

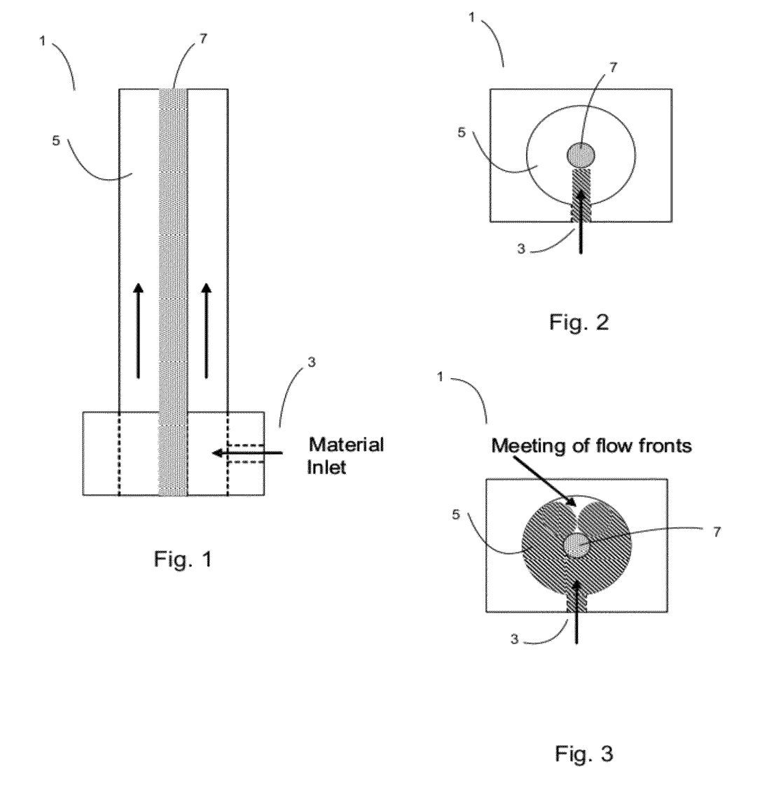

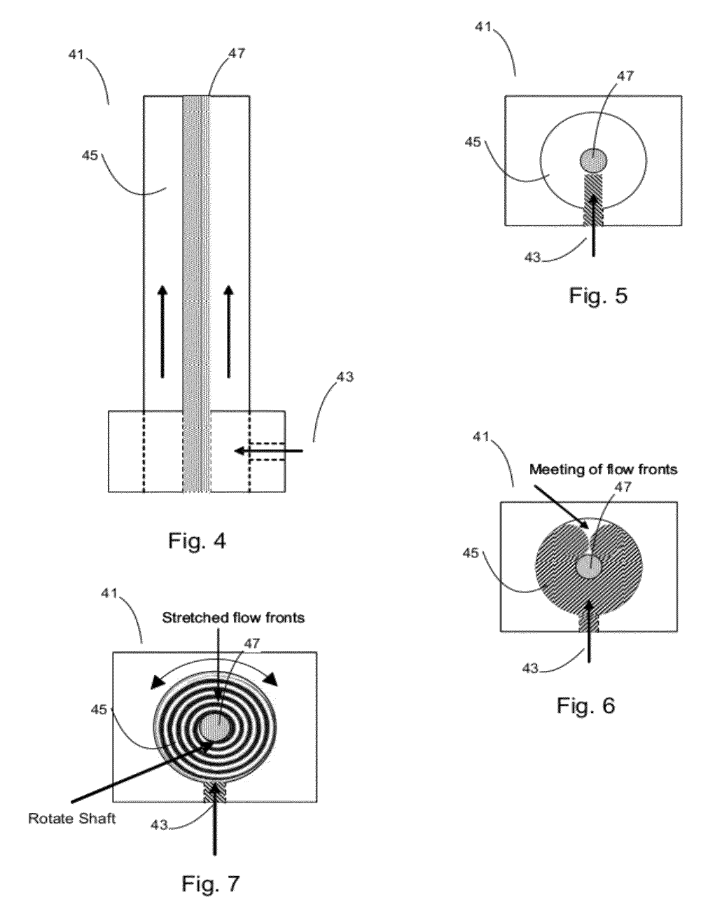

With reference to FIGS. 4-7, there is shown a process for manufacturing a roll member according to a first example embodiment. A mold 41 may have an inlet 43 for receiving the mold material and a main mold cavity 45 in communication with inlet 43. The flowable mold material may be, for example, a polyurethane rubber composition. Inlet 43 may be disposed along a bottom portion of mold 41, as shown in FIG. 4. Like in the existing mold system of FIGS. 1-3, material flowing into cavity 45 (FIG. 5) is split substantially evenly by developer roll shaft 47 into two separate, substantially parabolic flow fronts, as shown in FIG. 6. Such flow fronts flow around developer roll shaft 47 and eventually meet along a portion of cavity 45 that is substantially opposite inlet 43. Once contact is made between the flow fronts, the flowable material continues to fill cavity 45, moving upwardly towards the top thereof. As a result of the flow of material as described, weld and flow lines are formed along the longitudinal length of the developer roll, for substantially the entire length thereof.

Relatively soon after completion of the flow of material being injected into cavity 45, in accordance with an example embodiment, developer roll shaft 47 is rotated before the created developer roll is cured. Rotation of shaft 47 causes the weld line (exaggerated in FIG. 7) and flow lines to stretch in a substantially spiral pattern about the axis of shaft 47. Using existing roll processing techniques, weld lines are on the order of about 1 to about 2 mm wide run substantially the full length of the developer roller, which is about 230 mm. In order to reduce the width of a weld line to less than one half of its original width, thereby corresponding to the diameter of a single pel dot (about 40 microns), shaft 47 may be rotated at least about 20 rotations. Assuming that shaft 47 is about 9.5 mm in diameter and mold cavity 45 is about 22 mm in diameter, 20 rotations will result in a weld line that is approximately 20 microns wide. It is understood that 20 rotations of shaft 47 is a substantially minimum guideline, and rotating shaft 47 more than 20 revolutions will improve the effectiveness of the rotating by reducing the thickness of the weld line further. However, it is further understood that continuing to rotate shaft 47 beyond a certain number of shaft rotations will not result in a noticeable improvement in either weld line width or in reducing electrical property (voltage) variation along the circumference of the developer roll produced.

Rotation of shaft 47 may be for a predetermined time duration. For a polyurethane rubber composition having a viscosity in the range between about 5000 cP and about 8000 cP when entering mold cavity 45, the minimum time duration may be between about three seconds and about 15 seconds, and in particular between about ten seconds and about 15 seconds. This time duration may correspond to the rotation of shaft 47 being between about 80 rpm and about 300 rpm.

The time duration for rotating shaft 47, as well as the rate of shaft rotation, may vary depending upon the viscosity of the flowable material. For example, a flowable material having a relatively higher viscosity may allow for rotating shaft 47 for a longer period of time and/or at a lower rate of rotation. A flowable material having a relatively lower viscosity, on the other hand, may allow for a shorter period of time for rotating shaft 47 and/or a higher rate of shaft rotation.

Another factor which may affect the number of revolutions of shaft 47 may be the diameter of mold cavity 45. In particular, a mold cavity 45 having a diameter that is greater than about 22 mm may allow for less revolutions of shaft 47 to suitably stretch the flowable material.

The total duration of shaft rotation may be, for example, about 60 seconds. The shaft rotating is completed prior to the flowable material reaching its gel point. Continuing to rotate shaft 47 after the flowable material reaches its gel point may undesirably introduce mechanical defects in the produced roll.

It is further understood of a need to refrain from setting the speed of rotation of shaft 47 at such a relatively high rate so as to cause shaft 47 to slip, relative to the flowable material. Spinning shaft 47 too fast may result in the weld line not being sufficiently stretched.

Shaft 47 may be rotated by any of a number of mechanisms. For instance, the end portion of shaft 47 opposite the end to which inlet 43 is associated may be mechanically coupled to the shaft of a motor such that the motor's shaft and shaft 47 are substantially coaxial. Alternatively, the longitudinal axis of shaft 47 and the longitudinal axis of the shaft of the motor may be substantially parallel to each other. The motor may, for example, be an electric drill.

An alternative molding method, according to another example embodiment, is to spin shaft 47 during the time the flowable material is injected into mold cavity 45 through inlet 43. Rotating shaft 47 while the flowable material is being injected into mold cavity 45 can result in substantially the same result, but more rotations will be required as compared to spinning shaft 47 only after mold injection is complete. It is estimated that under the same shaft and mold dimensions, it would take more than about ten times the number of rotations of shaft 47 compared to spinning after injection is complete. The reason that more rotations may be required is that spinning shaft 47 during injection requires the weld line to be stretched in two dimensions instead of one. Basically, the weld line would follow a substantial corkscrew type pattern, similar in shape to a barber shop pole, about the axis of shaft 47. The weld line is thus being stretched circumferentially about the axis and parallel to the axis of shaft 47.

In another example embodiment, shaft 47 is rotated both during the injection of flowable material in mold 41 and following completion of such injection.

In yet another example embodiment, mold 41 is rotated while shaft 47 is held stationary. This may occur using a similar mechanism for rotating shaft 47. For example, an axle may extend from a top portion of mold 41 to which a motor or the like may be mechanically coupled. The rotation of mold 41 may occur only following the completion of flowable material being injected into mold cavity 45, only during the injection of the flowable material into mold cavity 45, or both during the injection of flowable material and thereafter.

In another embodiment, shaft 47 is rotated in one direction and mold 41 is rotated in another direction. This dual rotation may occur only following completion of flowable material being injected into mold cavity 45, only during the injection of the flowable material into mold cavity 45, or both during the injection and thereafter.

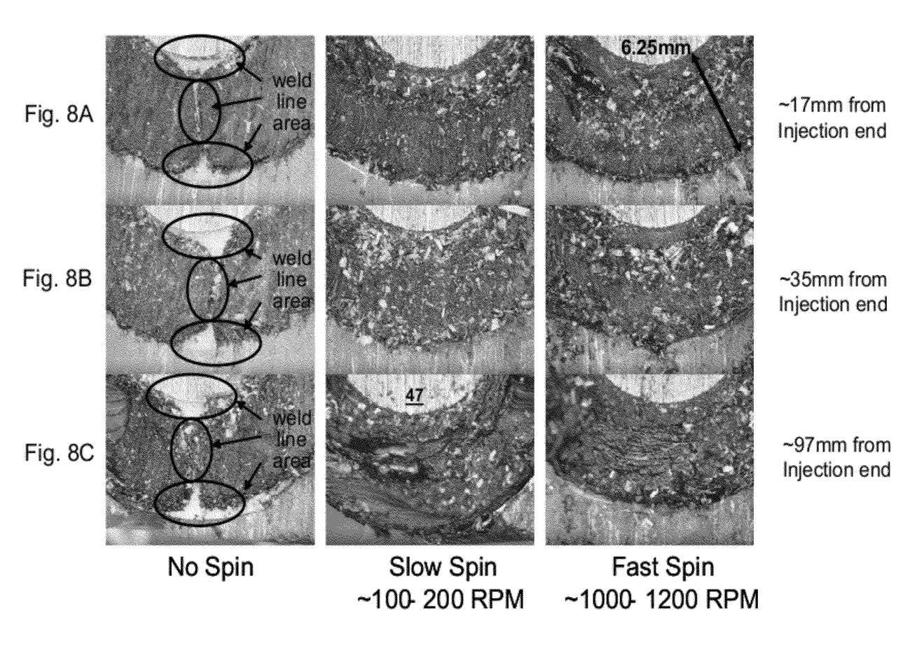

An experiment was conducted to determine the effectiveness of the above-identified processes. About 10 cc of white, slow setting epoxy was injected into the bottom of mold cavity 45 of a number of molds 41 prior to the reactive injection of the polyurethane rubber composition having a viscosity between about 5000 and about 8000 cP. In this particular case, the flowable polyurethane rubber composition included a black pigment to help provide adequate contrast between the weld line area and the bulk rubber. Substantially immediately after injecting the epoxy into cavity 47 of a mold 41, the black polyurethane rubber composition was injected via inlet 43. Following completion of the injection of the rubber composition into molds 41, shaft 47 of about one third of the molds 41 was spun at relatively low rotational speeds (i.e., between about 100 rpm and about 200 rpm), shaft 47 of another third of molds 41 were spun at relatively high rotational speeds (i.e., between about 1000 rpm and about 1200 rpm), and shaft 47 of the final one third of molds 41 were not rotated. The shaft rotations were carried out in the order that the parts were molded using a coupling adapter and a cordless drill. The shaft spinning was carried out for about ten seconds for each mold 41. The results of the experiment are shown in FIGS. 8A-8C.

FIG. 8A shows photographs of cross sections located about 17 mm from inlet 43 of molds 41. FIG. 8B shows photographs of cross sections about 35 mm from inlet 43 of molds 41, and FIG. 8C shows photographs of cross sections located near the middle of mold cavity 45 of molds 41. In each of FIGS. 8A-8C, the left-most image is of a roll that was not spun, the middle and right images are of rolls that had their shaft 47 spun at relatively low speed (about 100 rpm to about 200 rpm) and relatively high speed (about 1000 rpm to about 1200 rpm), respectively. In looking at the left image in each of FIGS. 8A-8C, a weld line resulting from the inability of the flow fronts to intimately mix is clearly visible. Each of the weld lines has three distinct regions, circled in the images. The middle region represents the bulk of the weld line, is about 1 mm to about 2 mm in width and spans approximately one third of the radius of the created roll, i.e., between shaft 47 and the outer surface of the roll. The inner and outer regions, located on either end of the middle region proximal to shaft 47 and to the outer surface of the created roll, respectively, are substantially triangular shaped regions. All of these regions are believed to pose problems in that they represent stagnant flow regions and result in electrical non-uniformities being formed around the circumference of the created roll at the region locations.

The role in which the above-mentioned middle region in the left-most image of FIGS. 8A-8C plays in created electrical non-uniformities depends upon the diameter of the created roll. When the mold diameter is relatively large, such as about 22 mm, the middle region has a higher probability of being a major cause for electrical non-uniformities being formed. However, as the mold diameter decreases, such as to about 17 mm, the center region shrinks in size, thereby leaving the inner and outer triangular regions to dictate the occurrence of electrical non-uniformities. If the triangular regions are more dominate relative to the middle region, the weld lines are likely to be noticeably wider and more pronounced in print samples. In other words, smaller diameter rolls will have weld lines that are noticeably worse than larger diameter rolls. The reason for the mold diameter effect is due to the parabolic velocity profile of the two flow fronts and the fact that the molded parts also undergo a grinding process that removes about 1 mm of the diameter from the roll. The images in FIGS. 8A-8C are as molded without grinding being performed.

The left-most images of FIGS. 8A-8C make clear the issue concerning weld lines. As can be seen in the middle and right-most images of FIGS. 8A-8C, i.e., the images of the rolls created as a result of the additional act of rotating shaft 47, there are no perceivable weld lines. Even at the interface with shaft 47 and outer (air) interface, virtually no sign of white epoxy is visible. Further, there are little if any visible artifacts in the created rolls at the intersection of the flow fronts. Additional experiments have shown that electrical uniformities at or near the regions of the flow fronts are substantially reduced or eliminated.

The foregoing description of multiple embodiments has been presented for purposes of illustration. It is not intended to be exhaustive or to limit the application to the precise forms disclosed, and obviously many modifications and variations are possible in light of the above teaching. It is understood that the subject matter of the present application may be practiced in ways other than as specifically set forth herein without departing from the scope and essential characteristics. It is intended that the scope of the application be defined by the claims appended hereto.

What is claimed is:

1. A method of manufacturing a roller having a shaft, comprising:
positioning the shaft within a mold;
injecting flowable material into the mold;
following the flowable material being injected into the mold, rotating one of the shaft and the mold; and
following the rotating, curing the flowable material.

2. The method of claim 1, wherein the rotating comprises rotating the one of the shaft and the mold at least about 20 revolutions.

3. The method of claim 2, wherein the rotating comprises rotating the one of the shaft and the mold between about 3 seconds and about 15 seconds.

4. The method of claim 1, wherein the rotating comprises rotating the one of the shaft and the mold between about 80 rpm and about 1200 rpm for a predetermined period of time.

5. The method of claim 1, wherein the rotating occurs for a period of time at a first rotation rate, at least one of the period of time and the first rotation rate being dependent upon a viscosity level of the flowable material.

6. The method of claim 1, further comprising ceasing the rotating prior to the flowable material reaching a gel point thereof.

7. The method of claim 1, further comprising rotating the one of the shaft and the mold during the injecting of the flowable material.

8. A roller, comprising:
a shaft;
material formed around the shaft, the material comprising a cured, moldable material, the material having a flow pattern forming one of a substantially spiral pattern and a substantially corkscrew shaped pattern about the shaft.

9. The roller of claim 8, wherein the flow pattern is the substantially spiral pattern.

10. The roller of claim 8, wherein the flow pattern is the substantially corkscrew shaped pattern.

11. A method for manufacturing a roll, comprising:
positioning a shaft for the roll within a cavity of a mold;
introducing flowable material into the mold from a first end thereof;
rotating the shaft at least about 20 revolutions; and
following introducing the flowable material into the mold and rotating the shaft, curing the material at an elevated temperature.

12. The method of claim 11, wherein the rotating is performed upon completion of the introducing of the flowable material.

13. The method of claim 11, wherein the rotating is performed at least partly during the introducing of the flowable material.

14. The method of claim 13, wherein the rotating is also performed following completion of the introducing of the flowable material.

15. The method of claim 11, wherein the rotating is performed for a predetermined period of time based upon a viscosity level of the flowable material.

16. The method of claim 15, wherein the predetermined period of time greater than about 3 seconds and less than a time at which the flowable material reaches a gel point of the flowable material.

17. The method of claim 15, wherein the predetermined period of time is between about 3 seconds and about 15 seconds.

18. The method of claim 11, wherein the rotating comprises rotating the shaft between about 100 revolutions per minute and about 1200 revolutions per minute.

19. The method of claim 18, wherein a diameter of the cavity of the mold is less than about 22 mm.
